(19) United States
(12) Patent Application Publication
(10) Pub. No.: US 2025/0073589 A1
(43) Pub. Date: Mar. 6, 2025

(54) INFORMATION PROCESSING PROGRAM, INFORMATION PROCESSING APPARATUS, AND INFORMATION PROCESSING METHOD

(71) Applicant: KOEI TECMO GAMES CO., LTD., Yokohama-shi (JP)

(72) Inventors: Kenichi OGASAWARA, Kanagawa (JP); Yuta KOBAYASHI, Kanagawa (JP)

(21) Appl. No.: 18/613,154

(22) Filed: Mar. 22, 2024

(30) Foreign Application Priority Data
Sep. 6, 2023 (JP) 2023-144875

(51) Int. Cl. A63F 13/5378

(52) U.S. Cl. CPC A63F 13/5378

(57) ABSTRACT

Provided are an information processing program, an information processing method, and an information processing apparatus for causing a computer to execute: displaying region data divided into plural regions by a predetermined method to be superimposed on map data; and arranging an object related to progress of a game for each of the regions.

### CROSS-REFERENCE TO RELATED APPLICATION

This application is based on and claims priority under 35 USC 119 from Japanese Patent Application No. 2023-144875, filed on Sep. 6, 2023, the disclosure of which is incorporated by reference herein.

### BACKGROUND

### Technical Field

The present disclosure relates to an information processing program, an information processing apparatus, and an information processing method.

### Related Art

Conventionally, position information games have been known in which a game progresses on the basis of position information of a terminal held by a player.

For example, Japanese Patent Application Laid-Open (JP-A) No. 2022-076018 discloses a position information game in which a game progresses as a game character operated by a player acquires an experience value by beating an enemy character and the game character is leveled up according to the acquired experience value.

By the way, in the position information games, there is no game in which a map is divided into predetermined regions for acquisition of a benefit related to the region.

### SUMMARY

An object of the disclosure is to provide an information processing program, an information processing method, and an information processing apparatus capable of implementing a position information game and offering a new game feature of acquiring a benefit related to a region obtained by dividing a map.

An information processing program according to a first aspect of the disclosure implements a position information game in which a user position specified from position information of a user moves in a virtual space, and causes a computer to execute: displaying region data divided into a plurality of regions by a predetermined method to be superimposed on map data; and arranging an object related to progress of a game for each of the regions.

An information processing program according to a second aspect of the disclosure is the information processing program according to the first aspect, and causes the computer to execute determining whether to grant a benefit related to the region in a case in which selection of the object from the user is received.

An information processing program according to a third aspect of the disclosure is the information processing program according to the second aspect, and causes the computer to execute: acquiring the position information of the user; and enabling acquisition of the benefit related to the region when a predetermined condition is satisfied in a case in which the position information is within the region.

An information processing program according to a fourth aspect of the disclosure is the information processing program according to the second aspect, in which the selection of the object is receivable in a case in which the position information is at a predetermined distance from the object.

An information processing program according to a fifth aspect of the disclosure is the information processing program according to any one of the first to fourth aspects, in which the region is defined by an administrative, legal, political, climatic, or geographical zone at present or in the past in a real space.

An information processing program according to a sixth aspect of the disclosure is the information processing program according to the fifth aspect, in which one of the regions is formed by combining the zone with another adjacent zone in a case in which the zone is smaller than a predetermined area.

An information processing program according to a seventh aspect of the disclosure is the information processing program according to the fifth aspect, and causes the computer to execute displaying address data of the zone to be superimposed on the map data.

An information processing method according to an eighth aspect of the disclosure implements a position information game in which a user position specified from position information of a user moves in a virtual space, and includes: displaying, by a computer, region data divided into a plurality of regions by a predetermined method to be superimposed on map data; and arranging, by the computer, an object related to progress of a game for each of the regions.

An information processing apparatus according to a ninth aspect of the disclosure implements a position information game in which a user position specified from position information of a user moves in a virtual space, and includes a processor, the processor being configured to display region data divided into a plurality of regions by a predetermined method to be superimposed on map data, and arrange an object related to progress of a game for each of the regions.

According to the disclosure, it is possible to provide the information processing program, the information processing method, and the information processing apparatus capable of implementing the position information game and offering the new game feature of acquiring the benefit related to the region obtained by dividing the map.

### BRIEF DESCRIPTION OF THE DRAWINGS

Exemplary embodiments of the present disclosure will be described in detail based on the following figures, wherein:

FIG. 1 is a diagram illustrating a schematic configuration of a game system 1 according to an embodiment of the disclosure;

FIG. 2 is a block diagram illustrating a hardware configuration of a mobile terminal;

FIG. 3 is a view for describing a system of a game provided by a game program according to the embodiment;

FIG. 4 is a view for describing the system of the game provided by the game program according to the embodiment;

FIG. 5 is a view illustrating an exemplary game screen displayed on a display unit by the game program;

FIG. 6 is a view illustrating an exemplary game screen displayed on the display unit by the game program; and

FIG. 7 is a flowchart illustrating a flow of information processing by the mobile terminal.

### DETAILED DESCRIPTION

Hereinafter, an example of an embodiment of the disclosure will be described with reference to the drawings. In the drawings, the same or equivalent constituent elements and portions are denoted by the same reference numerals. In addition, dimensional ratios in the drawings are exaggerated for convenience of description, and are sometimes different from actual ratios.

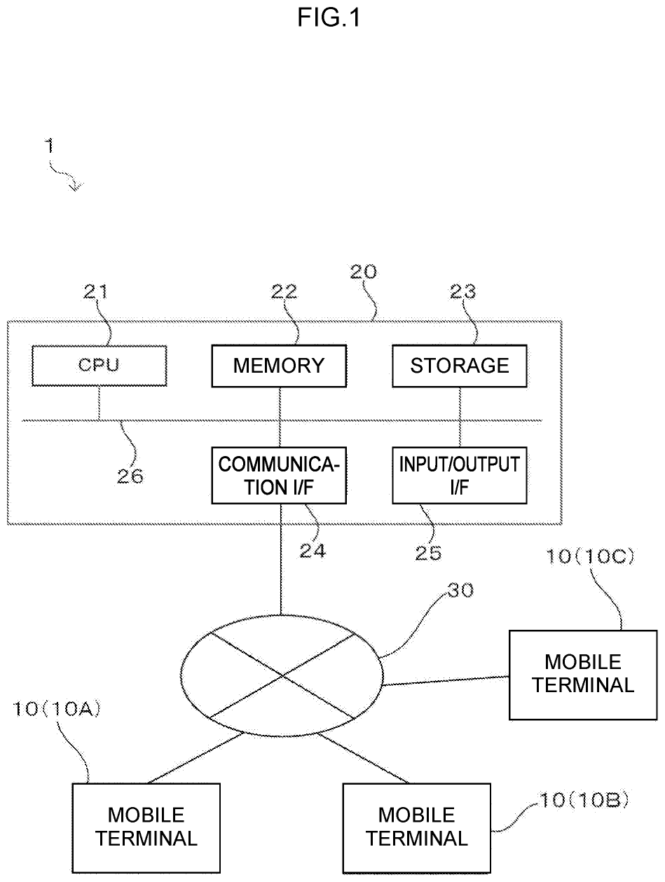

FIG. 1 is a diagram illustrating a schematic configuration of a game system 1 according to the embodiment. The game system 1 includes a plurality of mobile terminals 10A, 10B, and 10C which are examples of an information processing apparatus of the disclosure, and a server 20. The plurality of mobile terminals 10A, 10B, and 10C are examples of a user terminal device of the disclosure. The plurality of mobile terminals 10A, 10B, and 10C and the server 20 are connected to be capable of communicating with each other via a network 30. In the following description, the mobile terminals 10A, 10B, and 10C are simply described as the mobile terminal 10 when there is no need to distinguish therebetween. The mobile terminal 10 is a terminal including a touch panel, and examples thereof include a smartphone, a tablet, and the like.

The mobile terminal 10 executes a recorded game program. For example, the mobile terminal 10 downloads and installs the game program from a platform (application store) that distributes applications and the like. The mobile terminal 10 provides a user with an environment in which a game is played in response to execution of the game program. The mobile terminal 10 enables the user to play the game by executing the game program installed in the mobile terminal 10 by the user's operation or the game program installed in advance at the time of shipment. The mobile terminal 10 reads and executes the game program to communicate with the server 20. When the user plays the game, data related to the game is transmitted and received between the mobile terminal 10 and the server 20 according to the progress of the game in the mobile terminal 10.

The server 20 transmits data necessary for the play of the game on the mobile terminal 10 to the mobile terminal 10, if appropriate. As the data necessary for the play of the game on the mobile terminal 10 is transmitted from the server 20, the play of the game on the mobile terminal 10 progresses. The server 20 manages various types of data related to the game of each user playing the game on the mobile terminal 10. The server 20 communicates with the mobile terminal 10, and transmits an image, audio, text data, and other data to the mobile terminal 10 according to the progress of the game of each user.

The game program executed by the mobile terminal 10 is compatible with both single play in which one user plays the game and multi-play in which a plurality of user plays the game together. In the game system 1, the server 20 can provide each of the users with an environment in which the game is played in the multi-play by identifying the users who participate in the multi-play and communicating with each of the mobile terminals 10 of each of the users.

A hardware configuration of the server 20 will be described. The server 20 includes a CPU 21, a memory 22, a storage 23, a communication interface (I/F) 24, and an input/output interface (I/F) 25. The respective components are connected to be capable of communicating with each other via a bus 26.

The CPU 21 is a central processing unit, and executes various programs and controls each unit. That is, the CPU 21 reads the programs from the memory 22 or the storage 23, and executes the programs using the memory 22 as a work area. The CPU 21 performs control of each of the above-described components and various types of arithmetic processing according to the programs recorded in the memory 22 or the storage 23.

The memory 22 is a storage device configured to store data and the like used for various processes in the server 20. The memory 22 provides, for example, the work area to be temporarily used when the CPU 21 performs processing. The memory 22 includes a storage device such as a read only memory (ROM) and a random access memory (RAM).

The storage 23 includes a storage device such as a hard disk drive (HDD), a solid state drive (SSD), or a flash memory, and stores various programs including an operating system and various types of data. Information stored in the storage 23 includes the game program, information related to the game program, information of a user who plays the game program, map data used for the game, region data, and other information.

The communication I/F 24 is an interface for the server 20 to communicate with other devices. In the embodiment, the communication I/F 24 is compatible with various communication standards, for example, a local area network (LAN) standard and the like. The communication I/F 24 functions as an interface configured to transmit and receive data to and from an external communication device such as the mobile terminal 10 via the network 30.

The input/output I/F 25 functions as an interface configured to receive an input of information with respect to the server 20 and output information to the outside of the server 20. The input/output I/F 25 includes an input unit that receives connection of an input device such as a mouse or a keyboard, and an output unit that receives connection of an output device such as a display configured to displaying a letter, an image, and the like.

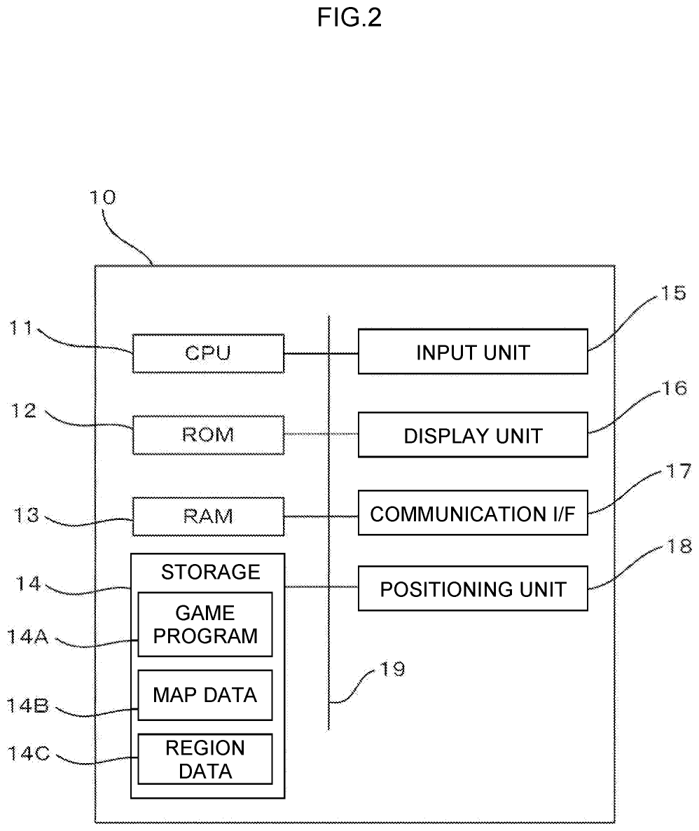

FIG. 2 is a block diagram illustrating a hardware configuration of the mobile terminal 10.

As illustrated in FIG. 2, the mobile terminal 10 includes a CPU 11, a ROM 12, a RAM 13, a storage 14, an input unit 15, a display unit 16, a communication interface (I/F) 17, and a positioning unit 18. The respective components are connected to be capable of communicating with each other via a bus 19. Here, the CPU 11 is an example of a processor of the disclosure.

The CPU 11 is a central processing unit, and executes various programs and controls each unit. That is, the CPU 11 reads the programs from the ROM 12 or the storage 14, and executes the programs using the RAM 13 as a work area. The CPU 11 performs control of each of the above-described components and various types of arithmetic processing according to the programs recorded in the ROM 12 or the storage 14. In the embodiment, the storage 14 stores a game program 14A as an information processing program of the disclosure, map data 14B, and region data 14C. The game program 14A is installed in the mobile terminal 10 by being downloaded from a platform (application store) that distributes applications and the like. When the CPU 11 executes the game program 14A, the mobile terminal 10 communicates with the server 20, if appropriate, and transmission and reception of data necessary for a game provided by the game program 14A are performed between the mobile terminal 10 and the server 20. In the embodiment, the map data 14B and the region data 14C are received from the server 20 and stored in the storage 14.

The ROM 12 stores various programs and various types of data. The RAM 13 temporarily stores the programs or data as the work area. The storage 14 includes a storage device such as an SSD or a flash memory, and stores various programs including an operating system and various types of data.

The input unit 15 includes a pointing device, such as a mouse, and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communication with other devices such as the server 20. For the communication, for example, a mobile communication system standard such as 4G or 5G, or a wireless communication standard such as Wi-Fi (registered trademark) is used.

The positioning unit 18 includes a positioning module that uses a satellite positioning system such as a global positioning system (GPS) module or a global navigation satellite system (GNSS) module, and measures position information of the mobile terminal 10 on the basis of a satellite positioning signal.

When the game program 14A is executed, the mobile terminal 10 implements various functions using the above-described hardware resources.

Next, a system of the game provided by the game program 14A according to the embodiment will be described.

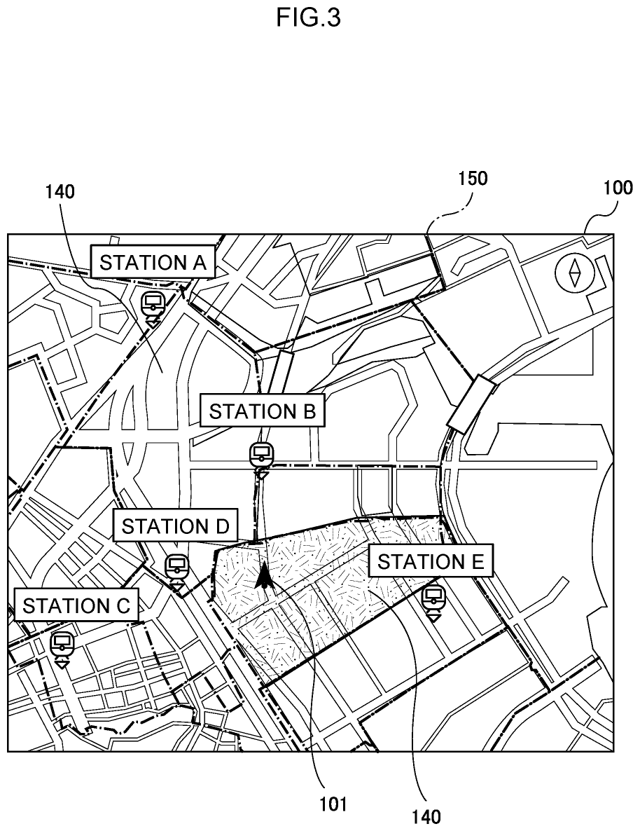

The game provided by the game program 14A is a position information game in which a position information of a user is acquired on the basis of position information of the mobile terminal 10 for movement in a virtual space according to the position information. As illustrated in FIG. 3, the region data 14C, obtained by dividing a map 100 into a plurality of regions 140 by a predetermined method, is displayed to be superimposed on the map data 14B in the virtual space. For example, the region data 14C obtained by dividing the map 100 into the plurality of regions 140 in association with predetermined progress of the game is displayed to be superimposed on the map data 14B. Here, the map data 14B is not based on the virtual space created for the game but is based on data representing a map of a real space. Therefore, the map displayed on the display unit 16 of the mobile terminal 10 is created on the basis of road information, facility information, and the like of the real space. In addition, the map data 14B in the embodiment includes line diagram information indicating roads, names of the roads, position information and names of facilities such as stations, and the like.

In addition, a current position of the user (hereinafter also referred to as “user position”) in the game is denoted by reference numeral 101 on the map 100. The CPU 11 specifies the user position from the position information of the mobile terminal 10 obtained by the mobile terminal 10 performing positioning using the positioning unit 18. When the user carrying the mobile terminal 10 moves in the real space, the user position on the map 100 in the virtual space also moves according to the movement of the user.

In addition, the region 140 is a range surrounded by a boundary line 150 indicated by a one-dot chain line in FIG. 3. Here, as the predetermined method, the region 140 is defined by an administrative, legal, political, climatic, or geographical zone at present or in the past in the real space. Examples of the region 140 include zones defined by a capital, a province, an urban prefecture, a rural prefecture, a district, a special ward, a city, a town, a village, a block number, a street number, a building number, a sub-district, and the like. That is, for example, the region data 14C indicating the region 140 divided according to a zone for each block number such as 1-chome and 2-chome is displayed to be superimposed on the map data 14B. With such a configuration, it is possible to achieve a new game feature of linking the real space in which the user playing the game actually lives and the virtual space of the game, and to improve a sense of immersion in the game. In addition, it is possible to create a new game feature of acquiring land in the real space as a territory.

In addition, the regions 140 are not limited to a case where all the regions 140 are defined by identical zones. For example, one region 140 may be the region 140 defined by “city”, and another region 140 may be the region 140 defined by “block”. With such a configuration, it is also possible to eliminate a bias in the population of the users playing the game. In addition, the regions 140 may include a section (for example, 0 m (meters) to 0.5 m, 0.5 m to 3.0 m, 3.0 m to 5.0 m, and the like of flood risks on a flood hazard map) for each rank of disaster on a hazard map of a cliff collapse, a mudslide, a landslide, or a flood.

In addition, when a zone is smaller than a predetermined area, one region 140 may be formed by combining the zone with another adjacent area. That is, for example, when the area of 1-chome is small, one region 140 may be formed by combining 1-chome with 2-chome. Here, when a zone is larger than a predetermined area, the zone may be divided into a plurality of zones to form a plurality of regions 140. In addition, on the basis of population data of zones, a zone exceeding a predetermined population may be divided into a plurality of zones to form a plurality of regions 140, and a zone less than the predetermined population may be combined with another zone to form one region 140. With such a configuration, it is also possible to eliminate a bias in the population of the users playing the game.

In addition, the respective regions 140 may be displayed in different colors when being displayed on the display unit 16 of the mobile terminal 10. In addition, a color of the region 140 where the user is located may be displayed in a different color from those of the other regions 140 as illustrated in FIG. 3. With such a configuration, it is possible to notify the user of the region 140 where the user is located, and to easily understand a selectable base to be described later.

Note that the map data 14B and the region data 14C are not limited to a case of being stored in advance in the storage 14 of the mobile terminal 10, and may be received from the server 20 if necessary with movement or the like of the mobile terminal 10 as a trigger and temporarily stored in the storage 14 or the RAM 13 of the mobile terminal 10. Here, types of the map data 14B and the region data 14C are not limited. For example, as the map data 14B, map data such as MAPBOX (registered trademark) may be used in addition to those created uniquely. In addition, as the region data 14C, region data that can be acquired from “Portal Site of Official Statistics of Japan” (https://www.e-stat.go.jp/) or the like may be used in addition to those created uniquely.

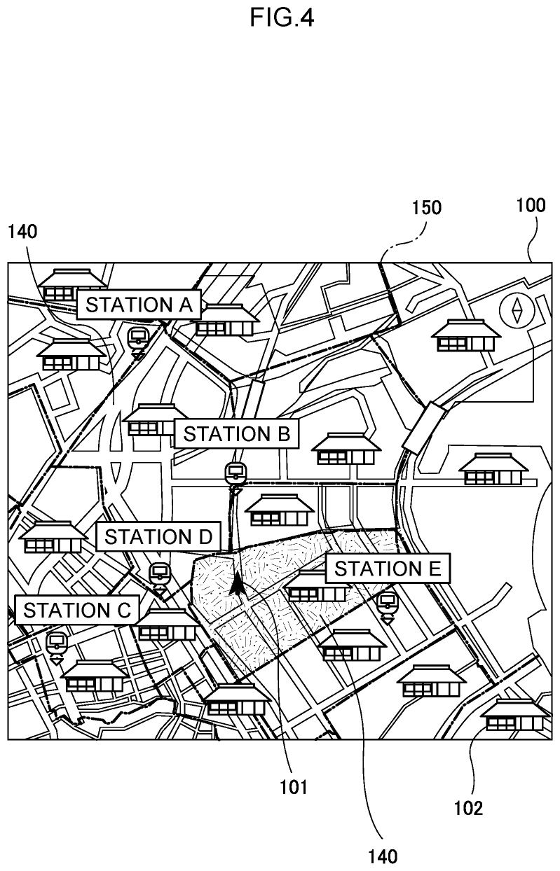

In addition, in the game provided by the game program 14A, a base 102 related to the progress of the game is arranged for each of the regions 140 in the virtual space as illustrated in FIG. 4. Here, the base 102 is an example of an object in the disclosure, and is configured using an image of a building in the embodiment. Note that an example of the object is not limited to the base 102 configured using the image of the building, and may be configured using, for example, an image of an item that can be used by the user, an enemy character, an animal, a robot, or the like.

In the embodiment, one base 102 is arranged for each of the regions 140. Note that a case where a plurality of the bases 102 are arranged for each of the regions 140 is not excluded. Here, places where the bases 102 are arranged include the center of each of the regions 140 and a predetermined facility such as a station or a historic site included in map data in each of the regions 140. Then, in a case in which the selection of the base 102 from the user is received, it is determined whether to grant a benefit related to the region 140. That is, in a case in which the user selects the base 102 by a touch operation, for example, an event of a battle against an enemy character associated with the base 102 occurs as an event related to the progress of the game. Then, in the case of winning the battle on the basis of a predetermined condition, the region 140 in which the base 102 is arranged is granted to the user as the benefit. The user advances a story or levels up a character in use by increasing the granted regions 140, thereby advancing the game.

Note that the game is not limited to a case where the game program 14A of the mobile terminal 10 provides all functions, and a program of the server 20 may provide some of the functions. In addition, the game system 1 does not necessarily include the server 20, and the game program 14A of the mobile terminal 10 may provide the above-described functions of the server 20.

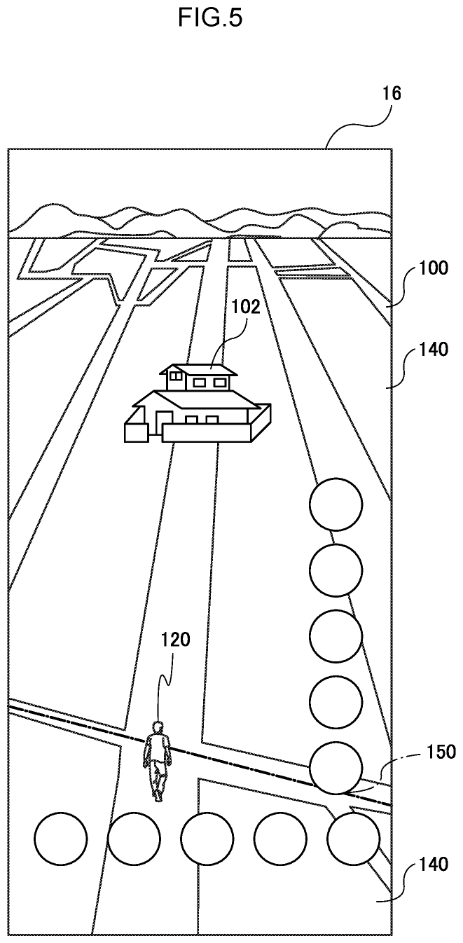

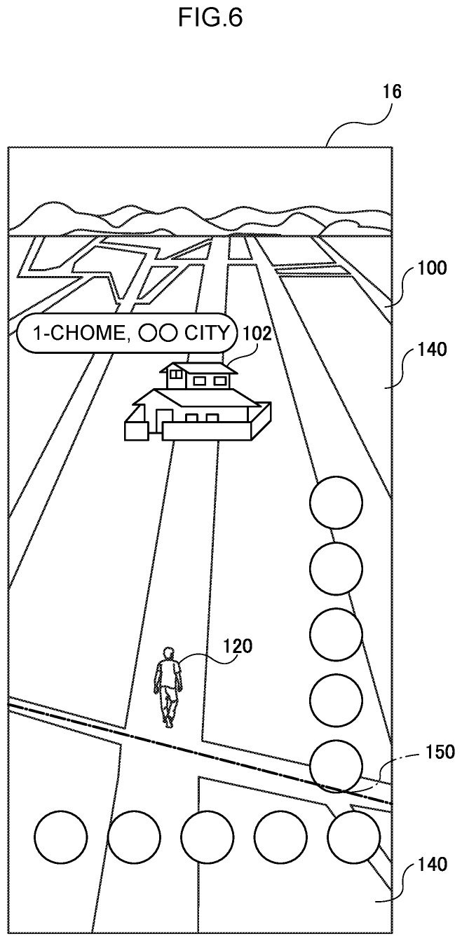

Next, selection of the base 102 will be described with reference to FIGS. 5 and 6.

FIG. 5 is an example of a case where the user character 120 and the base 102 are not present in the same region 140 so that the base 102 is not selectable. That is, as illustrated in FIG. 5, the game program 14A displays the user character 120 at the user position specified from the position information of the mobile terminal 10 on the map 100. In the example illustrated in FIG. 5, the position information is located on the front side of the boundary line 150 of the regions 140 and is not in the region 140 corresponding to the base 102. Thus, even if the user performs a touch operation to select the base 102, the touch operation is not received. Note that the boundary line 150 of the region 140 is not necessarily displayed on the display unit 16.

In the embodiment, the selection of the base 102 can be received in a case in which the user character 120 is at a predetermined distance from the base 102 even when the user character 120 and the base 102 are not present in the same region 140 although not illustrated. Therefore, the above-described example of FIG. 5 is an example of a case where the user character 120 is not at the predetermined distance from the base 102.

FIG. 6 is an example of a case where the user character 120 and the base 102 are present in the same region 140 so that the base 102 can be selected. That is, in the example illustrated in FIG. 6, the user moves in the real space from the state illustrated in FIG. 5, and the position information is updated in accordance with the movement to be located in the region 140 corresponding to the base 102 beyond the boundary line 150. Thus, when the user performs a touch operation to select the base 102, the touch operation is received. Note that the user may be notified of whether the touch operation is possible by, for example, changing a color of the region 140 or changing a color of the base 102 in a case in which the touch operation becomes possible.

As illustrated in FIG. 6, address data of a zone where the base 102 is displayed may be displayed in the base 102 to be superimposed on the map data. For example, it may be displayed as “1-chome, ○○ City”. With such a configuration, it is possible to achieve a new game feature of linking the real space in which the user playing the game actually lives and the virtual space of the game, and to improve a sense of immersion in the game. In addition, it is possible to create a new game feature of acquiring land in the real space as a territory. Regarding the display of the address data, address data of a zone where the user is located may be displayed, or address data of a zone where the user is not located may be displayed. In addition, in a case in which a benefit related to the region 140 can be acquired, address data of a corresponding zone may be displayed to be superimposed on the map data. With such a configuration, it is possible to create the new game feature of acquiring land in the real space as a territory.

Next, an operational effect of the mobile terminal 10 will be described.

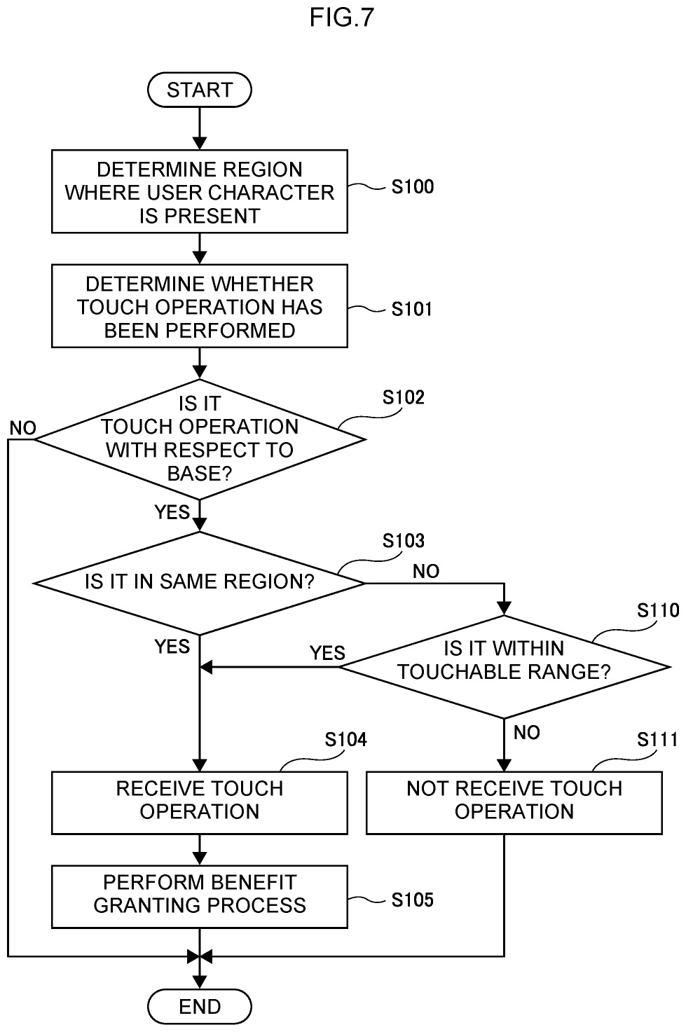

FIG. 7 is a flowchart illustrating a flow of processing related to selection of the base 102 by the mobile terminal 10. The CPU 11 reads the game program 14A from the storage 14, and develops and executes the game program 14A in the RAM 13, whereby information processing is performed. The flowchart illustrated in FIG. 7 is implemented while the CPU 11 executes the game program 14A. In addition, as a premise, the user character 120 is arranged on a game screen displayed on the display unit 16 according to a user position specified from position information of the mobile terminal 10.

In step S100, the CPU 11 determines the region 140 where the user character 120 arranged according to the user position specified from the position information of the mobile terminal 10 is present. Then, the processing proceeds to the next step S101.

In step S101, the CPU 11 determines whether a user has performed a touch operation on the display unit 16. Then, the processing proceeds to the next step S102.

In step S102, in a case in which the CPU 11 determines that the touch operation on the display unit 16 in step S101 is a touch operation with respect to the base 102, the processing proceeds to the next step S103. In a case in which the CPU 11 determines that there is no touch operation on the display unit 16, the processing is ended.

In step S103, in a case in which the CPU 11 determines that the base 102 touched by the user is a base in the same region 140 as the region 140 including the user position, the processing proceeds to the next step S104.

In step S104, the CPU 11 receives the touch operation by the user. Then, the processing proceeds to the next step S105.

In step S105, the CPU 11 performs a benefit granting process. In the embodiment, an event of a battle against an enemy character occurs and a win or not in the battle is determined. Then, in the case of the win in the battle, the region 140 is granted to the user as the benefit.

In a case in which the CPU 11 determines that the base 102 touched by the user is not the base 102 in the same region 140 as the region 140 including the user position in step S103 described above, the processing proceeds to step S110, and it is determined whether the touch operation is within a predetermined touchable range. Here, being within the predetermined touchable range is determined depending on whether the position information of the mobile terminal 10 is at a predetermined distance from the base 102. Then, in a case in which it is determined to be within the touchable range, the processing proceeds to step S104 described above. In a case in which it is determined not to be within the touchable range, the processing proceeds to the next step S111.

In step S111, the CPU 11 does not receive but ignores the touch operation received in step S101. Then, the processing is ended.

Although the embodiment of the present disclosure has been described in detail with reference to the accompanying drawings, a technical scope of the disclosure is not limited to such an example. It is obvious that a person with ordinary knowledge in the technical field of the disclosure can conceive various changes or modifications within a scope of the technical idea described in the claims, and it is understood that these changes or modifications naturally belong to the technical scope of the disclosure.

In addition, effects described in the above embodiment are illustrative or exemplary, and are not limited to those described in the above embodiment. That is, the technology according to the disclosure can exhibit other effects obvious to a person with ordinary knowledge in the technical field of the disclosure from the description in the above embodiment together with the effects described in the above embodiment or instead of the effects described in the above embodiment.

Although an aspect in which the program is stored (installed) in advance in the storage 14 has been described in the above embodiment, but the present disclosure is not limited thereto. The program may be provided in a form of being recorded in a recording medium such as a compact disk read only memory (CD-ROM), a digital versatile disk read only memory (DVD-ROM), or a universal serial bus (USB) memory. In addition, the program may be downloaded from an external device via the network 30.

In addition, the processor in the above embodiment refers to a processor in a broad sense, and includes general-purpose processors (for example, a central processing unit (CPU) and the like) and dedicated processors (for example, a graphics processing unit (GPU), an application specific integrated circuit (ASIC), a field programmable gate array (FPGA), a programmable logic device, and the like).

In addition, the game is a group of activities and rules for performing play and competition. The game is played, for example, by a player using strategies and skills to achieve a particular goal. The game is played to achieve various goals, for example, a goal in competition such as a win or lose, a goal in a battle such as beating an enemy, an educational goal such as learning, and a narrative goal such as completing the progress of a scenario. The game may be a format of competing against each other or a format of not competing against each other.

In addition, the operations of the processor described in the above embodiment are not only performed by one processor, but may be performed by a plurality of processors in collaboration which are located physically apart from each other but work cooperatively. In addition, the order of the operations of the processor is not limited to the order described in the above embodiment, and may be changed, if appropriate.

What is claimed is:

1. A non-transitory computer-readable recording medium in which an information processing program is recorded,
the information processing program implementing a position information game in which a user position specified from position information of a user moves in a virtual space,
the information processing program causing a computer to execute:
displaying region data divided into a plurality of regions by a predetermined method to be superimposed on map data; and
arranging an object related to progress of a game for each of the regions.

2. The non-transitory computer-readable recording medium in which the information processing program is recorded according to claim 1, the information processing program causing the computer to execute determining whether to grant a benefit related to the region in a case in which selection of the object from the user is received.

3. The non-transitory computer-readable recording medium in which the information processing program is recorded according to claim 2, the information processing program causing the computer to execute:
acquiring the position information of the user; and
enabling acquisition of the benefit related to the region when a predetermined condition is satisfied in a case in which the position information is within the region.

4. The non-transitory computer-readable recording medium in which the information processing program is recorded according to claim 2, wherein the selection of the object is receivable in a case in which the position information is at a predetermined distance from the object.

5. The non-transitory computer-readable recording medium in which the information processing program is recorded according to claim 1, wherein the region is defined by an administrative, legal, political, climatic, or geographical zone at present or in past in a real space.

6. The non-transitory computer-readable recording medium in which the information processing program is recorded according to claim 5, wherein in a case in which the zone is smaller than a predetermined area, one of the regions is formed by combining the zone with another adjacent zone.

7. The non-transitory computer-readable recording medium in which the information processing program is recorded according to claim 5, the information processing program causing the computer to execute displaying address data of the zone to be superimposed on the map data.

8. An information processing method for implementing a position information game in which a user position specified from position information of a user moves in a virtual space, the information processing method comprising:
displaying, by a computer, region data divided into a plurality of regions by a predetermined method to be superimposed on map data; and
arranging, by the computer, an object related to progress of a game for each of the regions.

9. An information processing apparatus implementing a position information game in which a user position specified from position information of a user moves in a virtual space, the information processing apparatus comprising
a processor,
the processor being configured to
display region data divided into a plurality of regions by a predetermined method to be superimposed on map data, and
arrange an object related to progress of a game for each of the regions.
